(19) United States
(12) Patent Application Publication
(10) Pub. No.: US 2016/0019644 A1
(43) Pub. Date: Jan. 21, 2016

(54) SIZE-BASED ALLOCATION PRIORITIZATION

(71) Applicant: Chicago Mercantile Exchange Inc., Chicago, IL (US)

(72) Inventors: James Boudreault, Chicago, IL (US); Jonathan Kronstein, Chicago, IL (US); Daniel Grombacher, Chicago, IL (US); Frederick Sturm, Chicago, IL (US); John Labuszewski, Chicago, IL (US)

(21) Appl. No.: 14/335,471

(22) Filed: Jul. 18, 2014

(51) Int. Cl. G06Q 40/04

(52) U.S. Cl. CPC G06Q 40/04

(57) ABSTRACT

The disclosed embodiments relate to systems and methods that match or allocate an incoming order to trade with a plurality of resting orders. Order book data indicative of the resting orders is obtained. An allocation priority listing of the plurality of resting orders is determined based on the order book data. The allocation priority listing prioritizes the plurality of resting orders by order price, and further prioritizes by order size those of the plurality of resting orders having an identical order price. A volume of the incoming order is allocated in accordance with the allocation priority listing by proceeding sequentially through the plurality of resting orders starting with the respective resting order listed first in the allocation priority listing. A successive resting order in the allocation priority listing is not filled until the respective resting order currently being filled is either filled completely or a fill limit is met.

### BACKGROUND

A financial instrument trading system, such as a futures exchange, referred to herein also as an “Exchange”, such as the Chicago Mercantile Exchange Inc. (CME), provides a contract market where financial products/instruments, for example futures and options on futures, are traded. The term “futures” is used to designate all contracts for the purchase or sale of financial instruments or physical commodities for future delivery or cash settlement on a commodity futures exchange. A futures contract is a legally binding agreement to buy or sell a commodity at a specified price at a predetermined future time, referred to as the expiration date or expiration month. An option is the right, but not the obligation, to sell or buy the underlying instrument (in this case, a futures contract) at a specified price within a specified time. The commodity to be delivered in fulfillment of the contract, or alternatively, the commodity, or other instrument/asset, for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract price.

Typically, the Exchange provides for a centralized “clearing house” through which all trades made must be confirmed, matched, and settled each day until offset or delivered. The clearing house is an adjunct to the Exchange, and may be an operating division thereof, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Current financial instrument trading systems allow traders to submit orders and receive confirmations, market data, and other information electronically via a network. These “electronic” marketplaces have largely supplanted the pit based trading systems whereby the traders, or their representatives, all physically stand in a designated location, i.e. a trading pit, and trade with each other via oral and hand based communication. In contrast to the pit based trading system where like-minded buyers and sellers can readily find each other to trade, electronic marketplaces must electronically “match” the orders placed by buyers and sellers on behalf thereof. Electronic trading systems may offer a more efficient and transparent system of trading. For example, in pit trading, subjective elements and limits on human interaction may unduly influence the process by which buyers and sellers come together to trade or otherwise limit the trading opportunities, limiting market liquidity. In contrast, an electronic exchange may be more objective when matching up a buyer and seller, relying solely on objective factors such as price and time of order placement, etc. As such, electronic trading systems may achieve more fair and equitable matching among traders as well as identify more opportunities to trade, thereby improving market liquidity.

### BRIEF DESCRIPTION OF THE DRAWINGS

FIG. 1 depicts an illustrative computer network system that may be used to implement aspects of the disclosed embodiments.

FIG. 2 is a block diagram of an exemplary implementation of the system of FIG. 1 for size-based allocation prioritization in accordance with one embodiment.

FIG. 3 depicts a flow chart showing operation of the systems of FIGS. 1 and 2.

FIG. 4 shows an illustrative embodiment of a general computer system for use with the systems of FIGS. 1 and 2.

FIG. 5 depicts an exemplary application of size-based allocation prioritization in accordance with one embodiment.

### DETAILED DESCRIPTION

The disclosed embodiments relate to systems and methods that match or otherwise allocate an incoming order to trade with “resting,” i.e., previously received but not yet matched, orders. The disclosed embodiments relate to a match engine that allocates the incoming order based on the size of the resting orders. At a given price, larger orders are prioritized over smaller orders. In some cases, for instance, the resting order with the largest size is matched first in its entirety by an incoming order before any allocation to the smaller orders. Large resting orders are thus encouraged by the disclosed embodiments.

To implement the size-based prioritization, a volume of an incoming order is allocated in accordance with an allocation priority listing having order price as a primary sort criterion and having order size as a secondary sort criterion. The secondary sort criterion prioritizes resting orders having an identical price. The allocation priority listing is used to allocate the volume by not filling a successive resting order in the listing until the largest current resting order is either filled completely or a fill limit is met. Thus, in the former case, the largest resting order in the listing is completely filled before any other resting orders are filled. In the latter case, the largest order is filled up to a fill limit (e.g., 500 contracts) before the next resting order in the listing is filled.

The disclosed embodiments implement a matching procedure that may vary after the resting order with the largest size is matched or allocated first. Once the largest resting order is entirely filled or a fill limit is reached, the next largest size order (again, at the best price) is matched or allocated next, and so on. If two resting orders at the best price have the same size, then the resting order that has time priority (i.e., that was entered first) is matched first, followed by the resting order that was second in time priority, and so on. In such cases, the size-based allocation may be considered to implement a price-size-time matching procedure. In other cases, the largest resting order may not be filled in its entirety or until a fill limit is reached. For example, a pro-rata and/or first-in, first-out allocation may be used in combination with the price-size-time allocation procedures described herein. Other hybrid procedures may be used as described herein.

The disclosed embodiments may allow a trader with a resting order to modify the size of the order to attain a higher position in the queue, or priority listing. The higher position may be attained despite an initially worse time priority. The higher position may be attained despite the even worse time priority of the size modification. The size-based prioritization of the disclosed embodiments may thus not reward order speed.

The larger order sizes incentivized by the disclosed embodiments may be useful in a number of ways. First, the disclosed embodiments may improve the efficiency of order matching and allocation. For example, an incoming order may be allocated to a lower number of resting orders (e.g., only a single resting order). With less trade allocations to implement, record, and otherwise process for a given incoming order, an exchange computer system may experience lower processing loads, decreased memory requirements, and/or lower network traffic demands. The efficiency of the exchange computer system may be improved in other ways as well.

The increase in average order book size promoted by the disclosed embodiments may result in higher trading volume and/or greater liquidity. For instance, the disclosed embodiments may encourage traders to place larger orders, which may, in turn, provide an increase in market making activity. With larger orders resting on the order book, other traders may, in turn, be encouraged to participate in the market. More widespread participation in electronic trading markets may thus be promoted. The disclosed embodiments may configure electronic trading markets to mimic one-to-one, or voice, trading previously used in swap and other OTC markets. As described below, traders may be accustomed to large fills from past experiences in OTC or other voice-executed markets. While the disclosed embodiments are described in connection with illiquid, inactive, and/or voice-executed markets, the disclosed embodiments may be useful in connection with a variety of different markets and financial products.

A variety of different matching algorithms or procedures may be used in conjunction with the size-based allocation of the disclosed embodiments. Examples of other allocation techniques, including time-stamp-based procedures (first-in, first-out, or FIFO), pro-rata procedures, and combinations thereof, are provided below. The disclosed embodiments may also be integrated with these and other procedures in various ways to provide a wide variety of hybrid procedures.

While the disclosed embodiments may be discussed in relation to interest rate swaps and/or other markets involving a Swap Execution Facility (“SEF”), it will be appreciated that they may be applicable to any security, derivative, or other financial product traded via any equity, options or futures trading system, e.g., exchange, Electronic Communication Network (“ECN”), Alternative Trading System (“ATS”), or market now available or later developed, e.g. cash, Futures, etc., as well as any instrument traded thereon. It will be appreciated that a trading environment, such as an exchange as described herein, implements one or more economic markets where rights and obligations may be traded. As such, a trading environment may be characterized by a need to maintain market integrity, transparency, predictability, fair/equitable access and participant expectations with respect thereto. For example, an exchange must respond to inputs, such as trader orders, cancellation, etc., in a manner as expected by the market participants, such as based on market data, e.g. prices, available counter-orders, etc., to provide an expected level of certainty that transactions will occur in a consistent and predictable manner and without unknown or unascertainable risks. In addition, it will be appreciated that electronic trading systems further impose additional expectations and demands by market participants as to transaction processing speed, latency, capacity and response time, while creating additional complexities relating thereto. Accordingly, as will be described, the disclosed embodiments may further include functionality to ensure that the expectations of market participants are met, e.g. that transactional integrity and predictable system responses are maintained.

As was discussed above, electronic trading systems ideally attempt to offer an objective, efficient, fair and balanced market where market prices reflect a true consensus of the value of products traded among the market participants, where the intentional or unintentional influence of human interaction is minimized, if not eliminated, and where unfair or inequitable advantages with respect to information access are minimized if not eliminated.

Further, as discussed above, an exchange provides one or more markets for the purchase and sale of various types of products including financial instruments such as stocks, bonds, futures contracts, options, and foreign currency exchanges. The instruments may be related to or representative of agricultural products or other commodities. Other instruments involve trading different cash flows or income streams. For instance, an interest rate swap (“IRS”) is a contractual agreement between two parties, i.e., the counterparties, where one stream of future interest payments is exchanged for another, e.g., a stream of fixed interest rate payments in exchange for a stream of floating interest rate payments, based on a specified principal amount.

Generally, each exchange establishes a specification for each market provided thereby that defines at least the product traded in the market, minimum quantities that must be traded, and minimum changes in price (e.g., tick size). For some types of products (e.g., futures or options), the specification further defines a quantity of the underlying product represented by one unit (or lot) of the product, and delivery and expiration dates. As will be described, the Exchange may further define the matching procedure, or rules, by which incoming orders will be matched or allocated to resting orders.

Some products on an exchange are traded in an open outcry environment where the exchange provides a location for buyers and sellers to meet and negotiate a price for a quantity of a product. Other products are traded on an electronic trading platform (e.g., an electronic exchange), also referred to herein as a trading platform, trading host or Exchange Computer System, where market participants, e.g. traders, use software to send orders to the trading platform. The order identifies the product, the quantity of the product the trader wishes to trade, a price at which the trader wishes to trade the product, and a direction of the order (i.e., whether the order is a bid, i.e., an offer to buy, or an ask, i.e., an offer to sell).

The Exchange Computer System, as will be described below, monitors incoming orders received thereby and attempts to identify, i.e., match or allocate, as will be described in more detail below, one or more previously received, but not yet matched, orders, i.e., limit orders to buy or sell a given quantity at a given price, referred to as “resting” orders, stored in an order book database, where each identified order is contra to the incoming order and has a favorable price relative to the incoming order. An incoming order may be an “aggressor” order, i.e., a market order to sell a given quantity at whatever may be the resting bid order price(s) or a market order to buy a given quantity at whatever may be the resting ask order price(s). In particular, if the incoming order is a bid, i.e., an offer to buy, then the identified order(s) will be an ask, i.e., an offer to sell, at a price that is identical to or lower than the bid price. Similarly, if the incoming order is an ask, i.e., an offer to sell, the identified order(s) will be a bid, i.e., an order to buy, at a price that is identical to or higher than the offer price.

Upon identification (matching) of a contra order(s), a minimum of the quantities associated with the identified order and the incoming order is matched and that quantity of each of the identified and incoming orders become two halves of a matched trade that is sent to a clearinghouse. The Exchange Computer System considers each identified order in this manner until either all of the identified orders have been considered or all of the quantity associated with the incoming order has been matched, i.e., the order has been filled. If any quantity of the incoming order remains, an entry may be created in the order book database and information regarding the incoming order is recorded therein, i.e., a resting order is placed on the order book for the remaining quantity to await a subsequent incoming order counter thereto. As a result, the disclosed embodiments are accordingly not limited to allocating incoming orders that are less than the total resting quantity. Alternatively, the disclosed embodiments may be configured to be applied in connection with only those incoming orders that are less than the total resting quantity.

Traders access the markets on a trading platform using trading software that receives and displays at least a portion of the order book for a market, i.e., at least a portion of the currently resting orders. The trading software enables a trader to provide parameters for an order for the product traded in the market, and transmits the order to the Exchange Computer System. The trading software typically includes a graphical user interface to display at least a price and quantity of some of the entries in the order book associated with the market. The number of entries of the order book displayed is generally preconfigured by the trading software, limited by the Exchange Computer System, or customized by the user. Some graphical user interfaces display order books of multiple markets of one or more trading platforms. The trader may be an individual who trades on his/her behalf, a broker trading on behalf of another person or entity, a group, or an entity. Furthermore, the trader may be a system that automatically generates and submits orders.

If the Exchange Computer System identifies that an incoming market order may be filled by a combination of multiple resting orders, e.g., the resting order(s) at the best price only partially fills the incoming order, the Exchange Computer System may allocate the remaining quantity of the incoming order, i.e., that which was not filled by the resting order(s) at the best price, among such identified orders in accordance with prioritization and allocation rules/algorithms, referred to as “matching algorithms” or “matching procedures,” as, for example, may be defined in the specification of the particular financial product or defined by the Exchange for multiple financial products. Similarly, if the Exchange Computer System identifies multiple orders contra to the incoming limit order and that have an identical price which is favorable to the price of the incoming order, i.e., the price is equal to or better, e.g., higher if the incoming order is a buy or lower if the incoming order is a sell, than the price of the incoming order, the Exchange Computer System may allocate the quantity of the incoming order among such identified orders in accordance with the matching algorithms as, for example, may be defined in the specification of the particular financial product or defined by the Exchange for multiple financial products.

As was noted above, an Exchange responds to inputs, such as trader orders, cancellation, etc., in a manner as expected by the market participants, such as based on market data, e.g., prices, available counter-orders, etc., to provide an expected level of certainty that transactions will occur in a consistent and predictable manner and without unknown or unascertainable risks. Accordingly, the method by which incoming orders are matched with resting orders may be defined so that traders know what the expected result will be when they place an order or have resting orders and an incoming order is received. Typically, the Exchange defines the matching algorithm to be used for a particular financial product, with or without input from the market participants. Once defined for a particular product, the matching algorithm is typically not altered, except in limited circumstances, such as to correct errors or improve operation, so as not to disrupt trader expectations. It will be appreciated that different products offered by a particular Exchange may use different matching algorithms.

For example, a first-in/first-out (FIFO) matching algorithm, also referred to as a “Price Time” algorithm, considers each identified order sequentially in accordance with when the identified order was received. A FIFO or Price Time algorithm considers the timestamp of each order in the order book. The quantity of the incoming order is matched to the quantity of the identified order received earliest, then quantities of the next earliest, and so on until the quantity of the incoming order is exhausted. A FIFO algorithm may be considered to provide a “first to better the market, first to be allocated” approach to matching.

Some product specifications define the use of a pro-rata matching procedure, where a quantity of an incoming order is allocated to each of a plurality of orders proportionally. The orders that qualify for the pro-rata allocation are those at the same price. The allocation may also be based on time priority in cases in which a pro rata allocation is implemented with a first-in, first-out allocation. Pro-rata procedures may thus be configured for price-time priority and pro-rata allocation.

Some Exchange Computer Systems provide a priority to certain standing orders in particular markets. An example of such an order is the first order that improves a price (i.e., improves the market) for the product during a trading session. To be given priority, the trading platform may require that the quantity associated with the order is at least a minimum quantity. Further, some Exchange Computer Systems cap the quantity of an incoming order that is allocated to a standing order on the basis of a priority for certain markets. In addition, some Exchange Computer Systems may give a preference to orders submitted by a trader who is designated as a market maker for the product. Other Exchange Computer Systems may use other criteria to determine whether orders submitted by a particular trader are given a preference. Typically, when the Exchange Computer System allocates a quantity of an incoming order to a plurality of identified orders at the same price, the trading host allocates a quantity of the incoming order to any orders that have been given priority. The Exchange Computer System thereafter allocates any remaining quantity of the incoming order to orders submitted by traders designated to have a preference, and then allocates any still remaining quantity of the incoming order using the FIFO or pro-rata algorithms. Pro-rata algorithms used in some markets may require that an allocation provided to a particular order in accordance with the pro-rata algorithm meet at least a minimum allocation quantity. Any orders that do not meet or exceed the minimum allocation quantity are allocated on a FIFO basis after the pro-rata allocation (if any quantity of the incoming order remains). More information regarding order allocation may be found in U.S. Pat. No. 7,853,499, the entire disclosure of which is incorporated by reference.

Other examples of matching procedures that may be used for allocation of orders of a particular financial product include:
Price Explicit Time
Order Level Pro Rata
Order Level Priority Pro Rata
Preference Price Explicit Time
Preference Order Level Pro Rata
Preference Order Level Priority Pro Rata
Threshold Pro-Rata
Priority Threshold Pro-Rata
Preference Threshold Pro-Rata
Priority Preference Threshold Pro-Rata
Split Price-Time Pro-Rata
   Any one or more of the above-listed matching procedures may be used in conjunction with, or otherwise integrated with, the size-based allocation procedures of the disclosed embodiments.

For example, the Price Explicit Time trading policy is based on the basic Price Time trading policy with Explicit Orders having priority over Implied Orders at the same price level. The order of traded volume allocation at a single price level may therefore be as follows:
Explicit order with oldest timestamp first. Followed by
Any remaining explicit orders in timestamp sequence (First In, First Out —FIFO) next. Followed by
Implied order with oldest timestamp next. Followed by
Any remaining implied orders in timestamp sequence (FIFO).

In Order Level Pro Rata, also referred to as Price Pro Rata, priority is given to orders at the best price (highest for a bid, lowest for an offer). If there are several orders at this best price, equal priority is given to every order at this price and incoming business is divided among these orders in proportion to their order size. The Pro Rata sequence of events is:
1. Extract all potential matching orders at best price from the order book into a list.
2. Sort the list by order size, largest order size first. If equal order sizes, oldest timestamp first. This is the matching list.
3. Find the ‘Matching order size’, which is the total size of all the orders in the matching list.
4. Find the ‘tradable volume’, which is the smallest of the matching volume and the volume left to trade on the incoming order.
5. Allocate volume to each order in the matching list in turn, starting at the beginning of the list. If all the tradable volume gets used up, orders near the end of the list may not get allocation.
6. The amount of volume to allocate to each order is given by the formula:

(Order volume/Matching volume)*Tradable volume
The result is rounded down (for example, 21.99999999 becomes 21) unless the result is less than 1, when it becomes 1.
7. If tradable volume remains when the last order in the list had been allocated to, return to step 3.
   Note: The matching list is not re-sorted, even though the volume has changed. The order that originally had the largest volume is still at the beginning of the list.
8. If there is still volume left to trade on the incoming order, repeat the entire algorithm at the next price level.

Order Level Priority Pro Rata, also referred to as Threshold Pro Rata, is similar to the Price (or ‘Vanilla’) Pro Rata algorithm but has a volume threshold defined. Any pro rata allocation below the threshold will be rounded down to 0. The initial pass of volume allocation is carried out in using pro rata; the second pass of volume allocation is carried out using Price Explicit Time. The Threshold Pro Rata sequence of events is:
1. Extract all potential matching orders at best price from the order book into a list.
2. Sort the list by explicit time priority, oldest timestamp first. This is the matching list.
3. Find the ‘Matching volume’, which is the total volume of all the orders in the matching list.
4. Find the ‘tradable volume’, which is the smallest of the matching volume and the volume left to trade on the incoming order.
5. Allocate volume to each order in the matching list in turn, starting at the beginning of the list.
6. The amount of volume to allocate to each order is given by the formula:

(Order volume/Matching volume)*Tradable volume
The result is rounded down to the nearest lot (for example, 21.99999999 becomes 21) unless the result is less than the defined threshold in which case it is rounded down to 0.
7. If tradable volume remains when the last order in the list had been allocated to, the remaining volume is allocated in time priority to the matching list.
8. If there is still volume left to trade on the incoming order, repeat the entire algorithm at the next price level.

In the Split Price Time Pro-Rata algorithms, a Price Time Percentage parameter is defined. This percentage of the matching volume at each price is allocated by the Price Explicit Time algorithm and the remainder is allocated by the Threshold Pro-Rata algorithm. There are four variants of this algorithm, with and without Priority and/or Preference. The Price Time Percentage parameter is an integer between 1 and 99. (A percentage of zero would be equivalent to using the respective existing Threshold Pro-Rata algorithm, and a percentage of 100 would be equivalent to using the respective existing Price Time algorithm). The Price Time Volume will be the residual incoming volume, after any priority and/or Preference allocation has been made, multiplied by the Price Time Percentage. Fractional parts will be rounded up, so the Price Time Volume will always be at least 1 lot and may be the entire incoming volume. The Price Time Volume is allocated to resting orders in strict time priority. Any remaining incoming volume after the Price Time Volume has been allocated will be allocated according to the respective Threshold Pro-Rata algorithm. The sequence of allocation, at each price level, is therefore:
1. Priority order, if applicable
2. Preference allocation, if applicable
3. Price Time allocation of the configured percentage of incoming volume
4. Threshold Pro-Rata allocation of any remaining incoming volume
5. Final allocation of any leftover lots in time sequence.
   Any resting order may receive multiple allocations from the various stages of the algorithm.

The disclosed embodiments may use any of the above-identified matching algorithms or procedures as an auxiliary, secondary, or other matching procedure. For example, the size-based allocation approach of the disclosed embodiments may be used for a certain percentage of an incoming order, while the remaining percentage of the incoming order may use one or more of the other techniques. It will be appreciated that there may be other allocation algorithms, including combinations of algorithms, now available or later developed, which may be utilized in conjunction with the disclosed embodiments, and all such algorithms are contemplated herein.

The matching algorithm may influence the behavior of the market or individual traders. For example, some allocation algorithms may encourage traders to submit more orders, where each order is relatively small. Other matching algorithms encourage traders to submit larger orders. Other matching algorithms may encourage a trader to use an electronic trading system that can monitor market activity and submit and retract orders on behalf of the trader very quickly and without intervention.

Market participants that trade electronically traded instruments often value liquidity. Liquidity may be provided via a combination of small bid/offer spreads with large resting order sizes at the top of the order book. More liquidity is desirable, especially when competing with OTC markets.

Pure price-time priority and allocation (e.g., FIFO) creates no incentive for aggregating large sized orders at the top of the order book. Price-time priority with pro-rata allocation does create an incentive for large-sized orders, but creates other problems as market participants attempt to tune their order sizes in an attempt to gain a larger percentage of the order allocation. For example, a trader may occasionally submit an order larger than actually desired to obtain a greater pro-rata share of the incoming order. Such tuning may lead to the risk of over-fill, insofar as estimating the proper order size to achieve a certain nominal allocation is complicated.

The disclosed embodiments may be useful in encouraging large order sizes while helping the traders avoid the risk of over-fill. To encourage larger orders, the disclosed embodiments may provide priority and, thus, a greater likelihood of full or substantial allocation, to the largest resting order. Traders may modify the size of their resting orders to attain a higher priority. In this way, the disclosed embodiments may accordingly not reward order speed as much as other procedures.

The disclosed embodiments may allow electronic trading platforms to mimic the behavior and results of non-electronic, one-to-one trading. In non-electronic trading (e.g., past OTC trading), liquidity may be provided by a large entity, such as a large bank, with significant resources sufficient to fill large orders, albeit less frequently (e.g., once per day). In that context, a trader contacting the bank to buy or sell IRS or other contracts would be likely given the opportunity to have an order completely filled. The telephone call provides a medium by which the liquidity provider can consider the clients' needs on a one-to-one basis and is afforded the time to fill the order in its entirety at a certain price. That medium is not available in electronic trading, and may no longer be favored by regulations governing swaps and other OTC products. In central limit order book (CLOB) or other electronic trading platforms, clients can only choose from what is immediately displayed in the CLOB or use other, existing mechanisms, such as requests-for-quote (RFQ) and requests-for-cross (RFC), in an effort to best replicate the advantages of one-to-one execution. The disclosed embodiments avoid relying on RFQ and RFC mechanisms by encouraging market participants (e.g., market makers) to quote large resting orders. Larger orders may provide the liquidity formerly available via one-to-one trading.

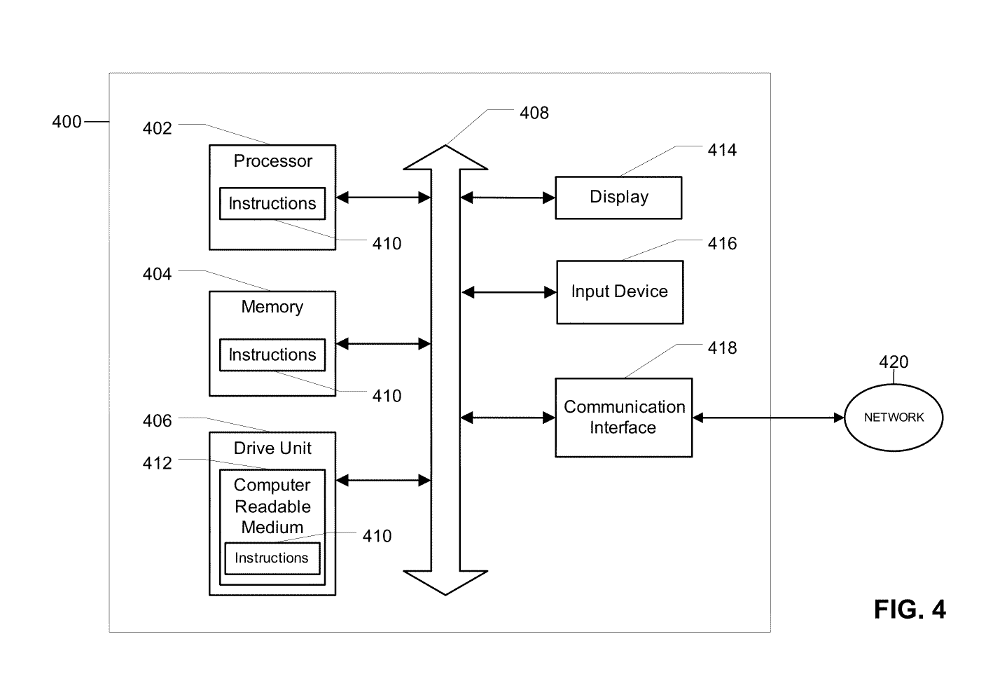

The disclosed embodiments may be implemented with computer devices and computer networks, such as those described with respect FIG. 4, that allow users, e.g. market participants or traders, to exchange trading information. It will be appreciated that the plurality of entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange.

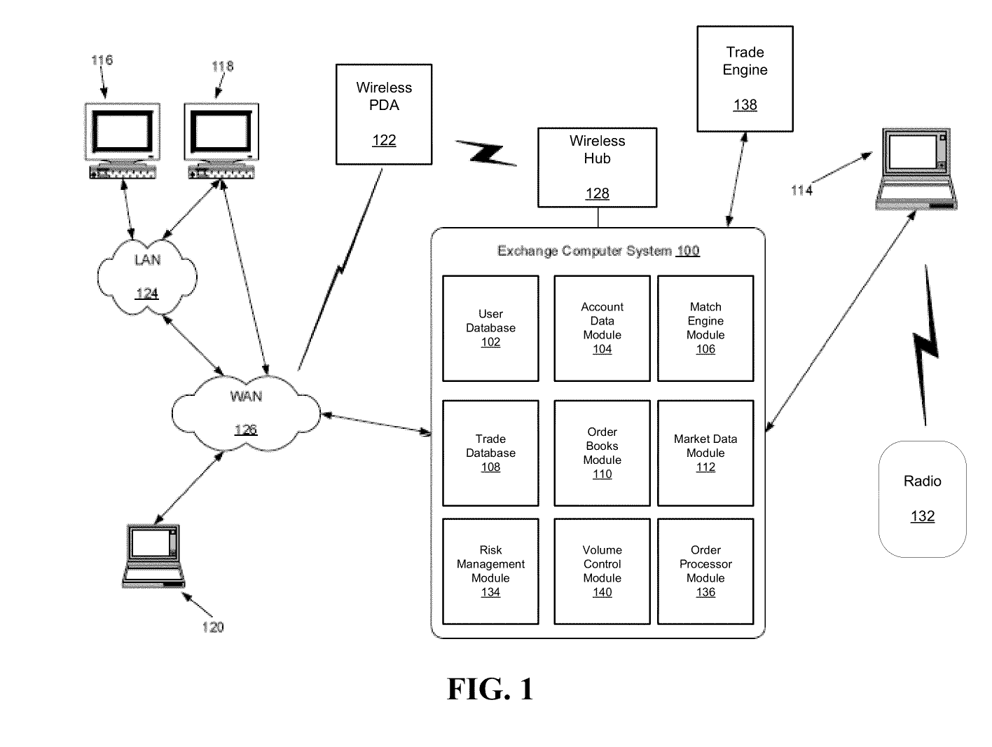

An exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as will be described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herein unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

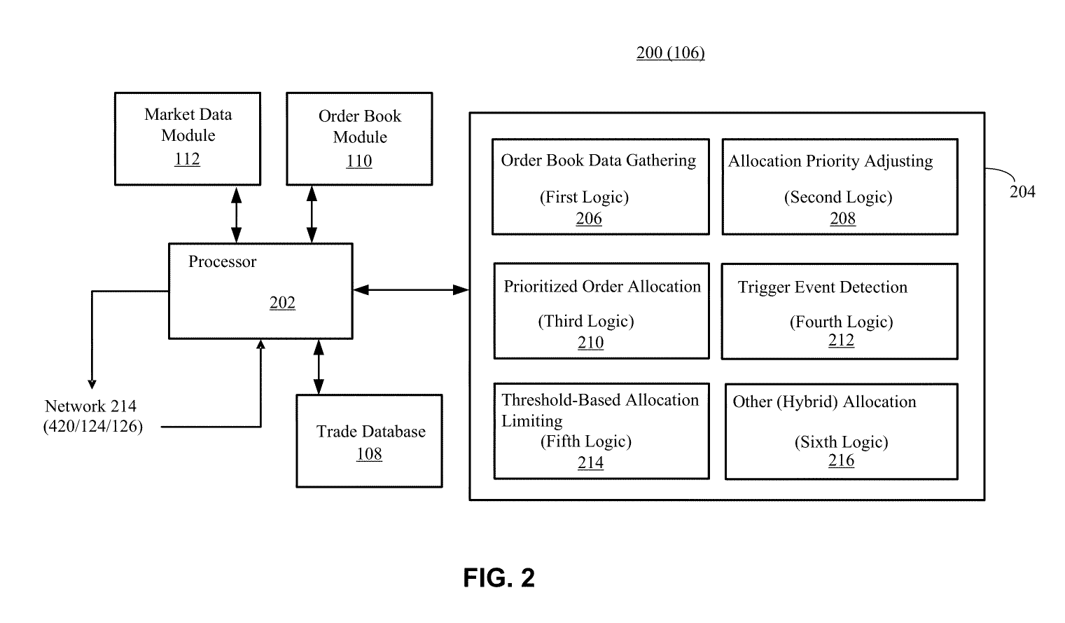

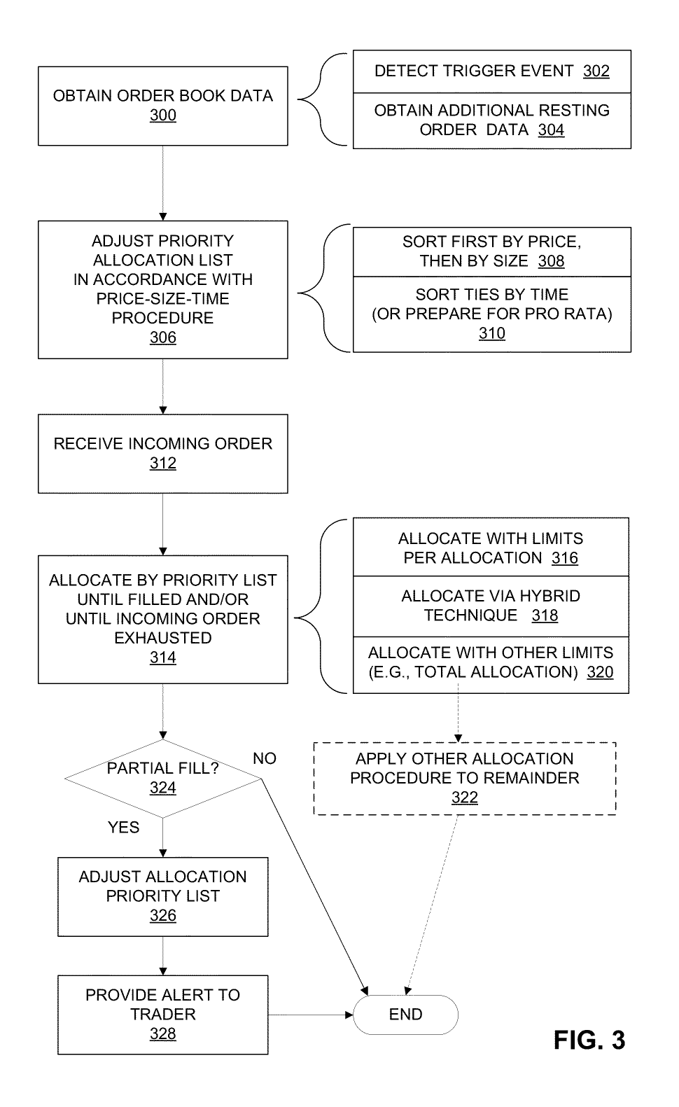

The exchange computer system 100 may be implemented with one or more mainframe, desktop or other computers, such as the computer 400 described below with respect to FIG. 4. A user database 102 may be provided which includes information identifying traders and other users of exchange computer system 100, such as account numbers or identifiers, user names and passwords. An account data module 104 may be provided which may process account information that may be used during trades. A match engine module 106 may be included to match bid and offer prices and may be implemented with software that executes algorithms for matching bids and offers as will be described in more detail below in connection with FIGS. 2 and 3. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by the order book module 110 and/or match engine module 106. A volume control module 140 may be included to, among other things, control the rate of acceptance of mass quote messages in accordance with one or more aspects of the disclosed embodiments. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122 which depict different exemplary methods or media by which a computer device may be coupled with the exchange computer system 100 or by which a user may communicate, e.g. send and receive, trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based computer device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

As was described above, the users of the exchange computer system 100 may include one or more market makers that may maintain a market by providing constant bid and offer prices for a derivative or security to the exchange computer system 100, such as via one of the exemplary computer devices depicted. The exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a computer-readable storage medium (as opposed to computer-readable communication media involving propagating signals) or a non-transitory computer-readable storage medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may include other components not shown and be connected by numerous alternative topologies.

FIG. 2 is a block diagram to depict the match engine module 106 according to one embodiment, which, in an exemplary implementation, is implemented as part of the exchange computer system 100 described above. As used herein, an exchange 100 includes a place or system that receives and/or executes orders.

In the example of FIG. 2, a system 200 is provided for matching, or otherwise allocating, an aggressor or other incoming order for a quantity of a financial product with one or more of a set of previously received unmatched (i.e., resting) orders for the financial product that are counter to the aggressor order, e.g., at the same or better price than the incoming order. In one embodiment, the financial product is a cash-market instrument, such as an IRS contract or other swap instrument. Alternatively, or in addition thereto, the financial product may include a derivative product such as a futures contract or option contract on a futures contract. The system 200 includes a processor 202 and a memory 204 coupled therewith. The processor 202 and the memory 204 may be implemented as a processor 402 and a memory 404 as described below with respect to FIG. 4.

During operation, the processor 202 may access the order book module 110 to receive or otherwise obtain data indicative of the resting orders and the incoming order. In the embodiment of FIG. 2, the system 200 includes first logic 206 stored in the memory 204 and executable by the processor 202 to cause the processor 202 to obtain order book data indicative of the plurality of resting orders. The data may be accessed at the outset, e.g., before implementation of the matching procedures, and/or during such implementation as needed. In some cases, the data may be temporarily stored in the memory 404 and/or another memory for use during operation. Temporary or other data generated during operation may also be stored in the memory 404 and/or another memory.

The order book data may specify a number of parameters for each resting order. The parameters include the price of the order, the size (quantity) of the order, and the time that the order was entered. The order time may alternatively or additionally specify the time at which the order was last modified. Additional order parameters may be specified and/or used in connection with the matching procedure. For example, the first logic 206 may cause the processor 202 to obtain other data to be processed in connection with matching, including, for instance, data from the trade database 108 and/or the market data module 112.

In some cases, the implementation of the first logic 206 may be initiated in response to an event. A variety of events may be detected and used to initiate the implementation of the first logic 206. In some cases, the event may involve the arrival of an incoming order (i.e., an order counter to the resting orders). Alternatively or additionally, the event may be related to a respective order of the plurality of resting orders. For example, one of the resting orders may be updated in an effort to attain a higher allocation priority. Detection of update may cause the processor 202 to access the order book module 110 to obtain the order book data. Additional, fewer, or alternative trigger events may be used. For example, one additional or alternative trigger event involves the allocation of an incoming order. In that case, implementation of the first logic 206 may be initiated upon completion of the allocation procedure of the disclosed embodiments.

Alternatively or additionally, the first logic 206 may be implemented periodically and/or in accordance with a schedule. For example, the order book data may be obtained daily, hourly, each minute, or at any other frequency.

The system 200 further includes second logic 208 stored in the memory 204 and executable by the processor 202 to cause the processor 202 to determine an allocation priority listing of the plurality of resting orders. The second logic 208 is configured such that the allocation priority listing has order price as a primary sort criterion. The resting orders are thus sorted first on price, best to worst. For example, if the resting orders are offers to buy (i.e., bids) ranging from $6 to $10, then the resting orders at $10 are higher in the allocation priority listing than those at lower prices. Conversely, if the resting orders are offers to sell (i.e., asks) ranging from $12 to $14, then the resting orders at $12 are higher in the allocation priority listing than those at higher prices.

The second logic 208 is also configured such that the allocation priority listing has order size (i.e., quantity) as a secondary sort criterion. As a secondary criterion, order size is used to prioritize resting orders having an identical price. Thus, after the resting orders are sorted by price, order size is then used to sort the resting orders at each given price. For a given price, larger orders are higher in the allocation priority listing than smaller orders. For example, a 100-lot order attains a higher position in the allocation priority listing than an 85-lot order.

In some cases, the second logic 208 is further executable by the processor 202 to cause the processor 202 to determine the allocation priority listing such that the allocation priority listing has order time as a tertiary criterion. A tertiary criterion prioritizes resting orders having an identical price and an identical size. For a given price and a given size, orders entered earlier are higher in the allocation priority listing than subsequently entered orders.

The order time may additionally take into account whether the resting order has been modified. For example, if the trader updated the order to change the price or size parameter, the time at which the update occurred may be considered the order time for purposes of allocation prioritization.

The manner in which the second logic 208 addresses resting orders having identical price and identical size may vary. For example, the second logic 208 may be further executable by the processor 202 to cause the processor 202 to not prioritize such resting orders (i.e., those having an identical price and an identical size). In such cases, the order in which such identical resting orders are listed in the allocation priority listing is not determinative of the allocation. A pro rata or other allocation procedure may be used to process such identical resting orders.

In the embodiment of FIG. 2, the second logic 208 is further executable by the processor 202 to cause the processor 202 to adjust a previously established allocation priority listing. The priority allocation listing may be adjusted or updated to address changes to the resting orders. For example, the allocation priority listing may be adjusted upon allocation or matching of an incoming order. Alternatively, the second logic 208 is further executable by the processor 202 to cause the processor 202 to generate a new allocation priority listing. In such cases, a preexisting listing may be discarded.

The system 200 further includes third logic 210 stored in the memory 204 and executable by the processor 202 to cause the processor 202 to allocate a volume of the incoming order in accordance with the allocation priority listing. The third logic 210 causes the processor 202 to proceed sequentially through the plurality of resting orders, starting with the respective resting order of the plurality of resting orders listed first in the allocation priority listing. As a result, a successive resting order of the plurality of resting orders in the allocation priority listing is not filled until the resting order currently being filled is either filled completely or a fill limit is met.

A fill limit may be a predetermined maximum allocation size for each resting order. The fill limit may thus specify a maximum number of contracts to be allocated to a respective resting order during any single pass through the allocation priority listing. For instance, for a particular type of IRS contract, the exchange may deem 500-lot orders to be sufficiently large for purposes of improving liquidity and providing other benefits. A 500-lot fill limit is then established for the IRS contract. In operation, a resting order may exceed the fill limit to attain a higher position in the allocation priority listing, but will only be partially filled. The 500 lots will be allocated to the resting order before proceeding to the next resting order in the allocation priority listing. The fill limit may be set at a sufficiently high level to dissuade traders from entering an artificially large order solely for purposes of attaining a high position in the allocation priority listing, with the intention of cancelling the rest of the order after the partial fill.

The third logic 210 may also cause the processor 202 to determine whether a partial fill occurs and/or implement one or more procedures in the event of a partial fill. A partial fill may occur with one or more of the resting orders due to the size of the incoming order, and/or to a fill limit. In some cases, the third logic 210 may configure the processor 202 to detect when a partial fill occurs, determine the remaining volume of the resting order, and update the order book to reflect the remaining volume. The remaining volume is determined by subtracting the matched volume from the size of the resting order. The processor 202 may update the order book by communicating with the order book module 110.

In other cases, one or more of the operations regarding partial fills may be implemented via logic separate from the third logic 210. For example, the communications with the order book module may be handled by the first logic 206 or other logic.

The third logic 210 may cause the processor 202 to implement the second logic 208 after the allocation is complete. The second logic 208 may be implemented again to adjust the allocation priority listing now that one or more of the resting orders has been completely or partially filled. A complete fill results in removal of the resting order from the listing. A partial fill may result in a re-sorting of the listing. For example, the second logic 208 may cause the processor 202 to re-position the partially filled resting order in accordance with the remaining volume. For example, the partially filled order was originally in the top position in the listing with an order size of 305 lots. But after the allocation, the partially filled order has a remaining volume of 26 lots. The partially filled order is then moved down in the allocation priority listing below any other resting orders having sizes greater than 26 lots.

In other embodiments, the allocation priority listing is not adjusted after an allocation that results in a partial fill. The partially filled resting order remains in the position in the listing as if the order had not been partially filled.

The third logic 210 may not use the prioritization provided via the allocation priority listing to determine all allocation amounts. In some cases, the third logic 210 may cause the processor 202 to allocate the volume of the incoming order in accordance with a matching procedure other than the price-size-time approach described above. For example, an incoming order may be allocated via a pro rata procedure in connection with resting orders having an identical price and an identical size. In such cases, the pro rata procedure effectively replaces the time-based (e.g., FIFO) approach described above as a tiebreaker or tertiary criterion. The pro rata procedure may thus be applied to those resting orders not prioritized via the second logic 208. The pro rata or other matching procedure may be implemented via logic separate from the third logic 210 (please see, e.g., sixth logic 216 described below).

In the embodiment of FIG. 2, the system 200 further includes fourth logic 212 stored in the memory 204 and executable by the processor 202 to cause the processor 202 to detect a trigger event. The trigger event detection may be used to initiate implementation of the allocation prioritization procedure. For example, the trigger event may cause the processor 202 to implement the first logic 206 and/or the second logic 208 to generate, update, or adjust the allocation priority listing.

The trigger event may relate to, or involve, one or more of the resting orders. For example, the trigger event may include or involve the entry of a respective resting order. Alternatively or additionally, the trigger event may include or involve the modification of a respective resting order. Additional, fewer, and alternative types of trigger events may be established.

In some cases, the fourth logic 212 may integrated with one or more of the other logic units. For example, the fourth logic 212 may be a component of the first logic 206. The extent of the integration may vary.

In the embodiment of FIG. 2, the system 200 further includes fifth logic 214 stored in the memory 204 and executable by the processor 202 to cause the processor 202 to specify and enforce one or more allocation limits. The allocation limit(s) may specify a maximum aggregate fill level for matching an incoming order in accordance with the size-based allocation described herein. The maximum aggregate fill level may allow an incoming order to be allocate in accordance with the allocation priority list until a predetermined percentage of the incoming order is matched. Once the predetermined percentage is reached, then the incoming order may be allocated to the resting orders in accordance with another type of matching procedure.

The fifth logic 214 may be integrated with one or more of the other logic units. For example, the fifth logic 214 may be a component of the third logic 210.

In some embodiments, the system 200 may further include sixth logic 216 stored in the memory 204 and executable by the processor 202 to cause the processor 202 to allocate a remaining volume of the incoming order in accordance with a further matching procedure. The remaining volume may be present, for example, once the processor 202 implements the fifth logic 214 to thereby limit the total volume handled by the size-based allocation procedure.

After the sized-based allocation procedure is implemented via the third logic 210, the sixth logic 216 may cause the processor 202 to implement one or more further matching procedures to allocate the remaining percentage of the incoming order (e.g., 80% of the incoming order). The further matching procedure may be configured to implement a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

FIG. 3 depicts a flow chart showing operation of the system 200 of FIG. 2. In particular, FIG. 3 shows a computer implemented method for matching, or otherwise allocating, an incoming order for a quantity of a financial product with one or more of a plurality of resting orders that are unmatched and counter to the incoming order, e.g., at the same or better price than the first order. The financial product may vary as described above. The order of the acts or steps of the operation may vary from the example shown. For example, the incoming order may be received before or during the generation of an allocation priority listing. Additional, fewer, or alternative acts may be implemented. For example, alerts may not be transmitted to traders in connection with adjustments to the allocation priority list.

The operation of the system 200 may begin with obtaining order book data indicative of the plurality of resting orders [block 300]. The order book data may be obtained by accessing the order book or the order book module 110 (FIG. 1). Alternatively or additionally, the order book data may be received from the order book module 110. For example, the order book module 110 may automatically transmit the order book data upon receipt of an additional or modified order and/or at regular intervals.

In some cases, the order book data is obtained upon detection of a trigger event [block 302]. The trigger event may be related to one or more of the resting orders. For example, the trigger event may include or involve entry or modification of a respective resting order. The order book data may then be obtained for the entered or modified order [block 304]. Alternatively, data indicative of the entire order book may be obtained.

An allocation priority listing is determined for the resting orders [block 306]. In the embodiment of FIG. 3, the allocation priority listing is adjusted or otherwise determined in accordance with a price-size-time procedure that sorts first by price, then by size [block 310]. In that case, order price is the primary criterion for sorting the resting orders, and order size is the secondary sort criterion. As the secondary sort criterion, order size is used to prioritize resting orders of the plurality of resting orders having an identical price.

Resting orders having identical prices and sizes may then be sorted by entry time [block 310]. The allocation priority listing may thus have order time as a tertiary criterion to prioritize resting orders having an identical price and an identical size. Other embodiments may not sort such price-size identical resting orders but rather prepare for application of a different allocation procedure, such as pro rata allocation.

A previously established allocation priority listing may be adjusted in block 306. Alternatively, the allocation priority listing is generated without utilizing any previous listing or listing data. In some cases, implementation of blocks 300 and 306 may be repeated periodically after an initial generation of the allocation priority listing. The listing may be updated daily, hourly, or at other intervals. The listings may then be consulted or used in between the updates to address incoming orders. In the embodiment of FIG. 3, an incoming order is received [block 312]. The timing of the incoming order may vary from the example shown. In an alternative embodiment, the priority allocation listing is adjusted or otherwise established on-the-fly upon receipt of the incoming order. Such on-demand prioritization may be useful in relatively illiquid or inactive markets.

A volume of the incoming order is allocated in accordance with the allocation priority listing [block 314]. Allocation proceeds via the listing until the incoming order is exhausted or until all of the resting orders are completely filled. Allocation via the listing proceeds sequentially through the resting orders starting with the resting order listed first in the allocation priority listing (i.e., the largest order at the best price). As a result, a successive resting order is not filled until the first (or current) resting order currently being filled is either filled completely or a fill limit is met.

In some cases, a fill limit is established for each resting order. The fill limit may specify a maximum allocation size for each resting order as described above. Allocation in accordance with the allocation priority listing may thus proceed with limits for each resting order allocation [block 316].

Allocation may alternatively or additionally proceed in accordance with a hybrid technique [block 318]. For example, allocation may proceed in accordance with the primary and secondary sort criteria of the priority allocation listing, but use a different matching technique for resting orders having identical prices and identical sizes. In some cases, the different matching technique is pro rata allocation. A variety of other techniques may be used, including, for example, techniques that integrate FIFO and pro rata approaches.

The procedure may deviate from a pure price-size-time prioritization in additional or alternative ways. For example, in some cases, the incoming order is allocated in accordance with the allocation priority list until a predetermined percentage of the incoming order is matched [block 320]. The relative volume of the size-based allocation may thus be controlled. A remainder of the incoming order may then be allocated in accordance with one or more other allocation procedures [block 322]. For example, 90% of each incoming order may be matched using the allocation priority listing. The remaining 10% of the incoming order may then be allocated in accordance with a time-based procedure. After reaching the predetermined percentage, allocating a remaining volume of the incoming order in accordance with a further matching procedure, a remaining volume of the incoming order may be allocated in accordance with a further matching procedure [block 322]. The switch between different matching procedures may occur in ways other than percentage-based divisions. For example, the switch may occur after the top three traders are filled via the price-size-time allocation procedure. The further matching procedure may also vary as described above.

In the embodiment of FIG. 3, the method includes determining whether allocation of the volume of the incoming order results in a partial fill of one of the resting orders [block 324]. If yes, the partial fill determination may be used to adjust the allocation priority list, as described above [block 326]. In some cases, the trader is provided with an alert regarding the adjustment [block 328]. If the allocation does not result in a partial fill, the method may terminate or return to a state associated with one of the above-described blocks for another iteration. In other embodiments, partial fill adjustments are not implemented, and the position of the partially filled resting order does not change even though other resting orders are now larger as a result of the partial fill.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above may be a computer system 400 or a component in the computer system 400. The computer system 400 may implement a match engine on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate with a drive unit 406 and other components of the system 400 via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data.

The memory 404 is operable to store instructions 410 executable by the processor 402. The functions, acts or tasks illustrated in the figures or described herein may be performed by the programmed processor 402 executing the instructions 410 stored in the memory 404. The instructions 410 may be loaded or accessed from a computer-readable storage medium 412 in the drive unit 406 or other data storage device. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include an optical or other disk drive unit as the drive unit 406. The disk drive unit 406 may include the computer-readable storage medium 412 in which one or more sets of instructions 410, e.g. software, can be embedded. Further, the instructions 410 may embody one or more of the methods or logic as described herein. In a particular embodiment, the instructions 410 may reside completely, or at least partially, within the memory 404 and/or within the processor 402 during execution by the computer system 400. The memory 404 and the processor 402 also may include computer-readable storage media as discussed above.

The present disclosure contemplates a computer-readable medium that includes instructions 410 or receives and executes instructions 410 responsive to a propagated signal, which may be received via a communication interface 418. The system 400 may be connected to a network 420 to communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

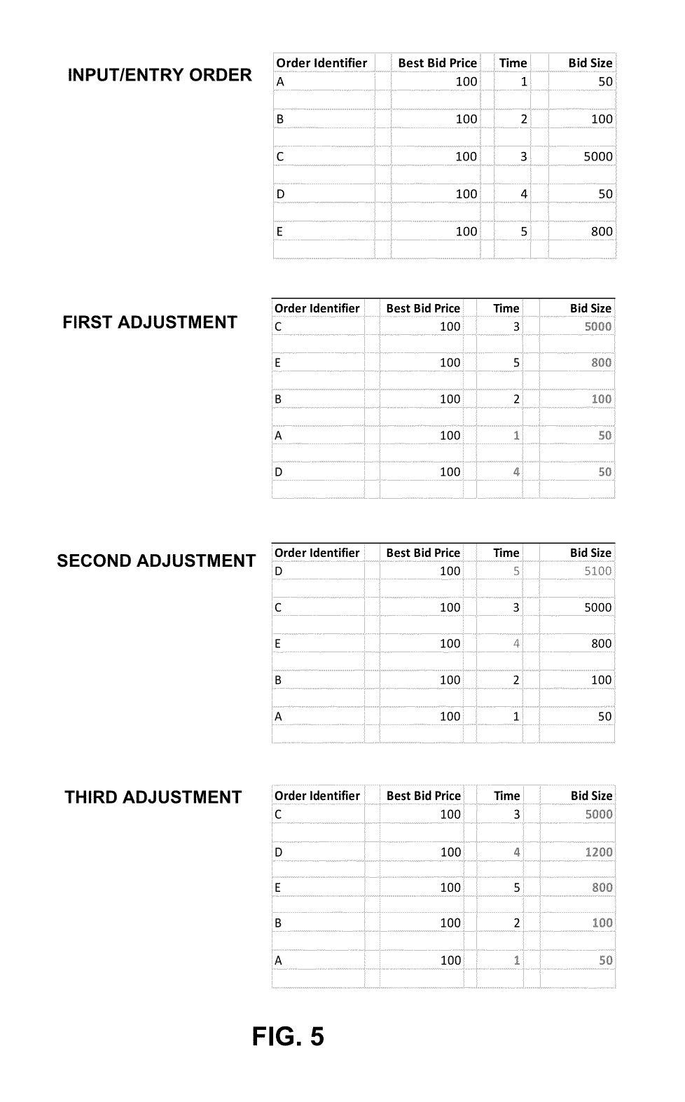

FIG. 5 depicts an exemplary application of a sized-based allocation procedure. In this embodiment, the procedure may implement a price-size-time allocation prioritization. As described above, the prioritization sorts the resting orders first on price, then on size, then on time. In this embodiment, the order with the largest resting size is allocated first in its entirety from the incoming order. Once the largest sized resting order is entirely filled, the next largest size order with the same price is allocated next, up to its entirety, and so on. If two orders have the same size at the same price, the order that has time priority (i.e., the order that was placed first) is filled first, followed by the next order of the same size and same price, that was second in time priority, and so on.

Five resting orders from traders A-E are entered in the time order (at increasing time points 1-5) shown in the “INPUT/ENTRY ORDER” table, each with the same price for ease in illustration. In this example, each order has a respective bid size (e.g., 50 lots, 100 lots, etc.). The allocation priority listing is then generated and shown in the “FIRST ADJUSTMENT” table. The resting orders are sorted based on bid size, with the 5000-lot order from trader C at the top or first position (despite being third in time).

The traders may be notified of the prioritization. For example, the traders may have access to an order book interface, which may be modified to reflect the first adjustment. In this example, trader D elects to attain an improved position, and modifies its bid size to 5100 lots. The allocation priority listing is then adjusted as shown in the “SECOND ADJUSTMENT” table.

The “THIRD ADJUSTMENT” table depicts the status of the allocation priority listing after a partial fill of the resting order from trader D. In this example, the partial fill results in a remaining volume of 1200 lots. At that point, the resting orders are sorted again on size to adjust the allocation priority again

The example of FIG. 5 thus depicts how the position of any resting order at the best price is modified as a result of a change in order size. As shown, the resting order may be modified to such a degree that the modified order moves to the top position in the queue for full allocation upon receipt of an incoming order. The move to the top position occurs despite the order having the worse time priority.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the terms “computer-readable medium” and “computer-readable storage medium” include a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable storage medium may be or include a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The disclosed computer programs (also known as a program, software, software application, script, or code) can be written in any form of programming language, including compiled or interpreted languages. The disclosed computer programs can be deployed in any form, including as a standalone program or as a module, component, subroutine, or other unit suitable for use in a computing environment. Such computer programs do not necessarily correspond to a file in a file system. Such programs can be stored in a portion of a file that holds other programs or data (e.g., one or more scripts stored in a markup language document), in a single file dedicated to the program in question, or in multiple coordinated files (e.g., files that store one or more modules, sub programs, or portions of code). Such computer programs can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor may receive instructions and data from a read only memory or a random access memory or both. The essential elements of a computer are a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method for matching an incoming order for a quantity of a financial product, the method comprising:
obtaining, by a processor, order book data indicative of a plurality of resting orders for the financial product that are unmatched and counter to the incoming order;
determining, with the processor, an allocation priority listing of the plurality of resting orders based on the order book data, the allocation priority listing prioritizing the plurality of resting orders by order price, and further prioritizing by order size those of the plurality of resting orders having an identical order price; and
allocating, by the processor, a volume of the incoming order in accordance with the allocation priority listing by proceeding sequentially through the plurality of resting orders starting with the respective resting order of the plurality of resting orders listed first in the allocation priority listing, such that a successive resting order of the plurality of resting orders in the allocation priority listing is not filled until the respective resting order of the plurality of resting orders currently being filled is either filled completely or a fill limit is met.

2. The computer implemented method of claim 1 wherein the allocation priority listing further prioritizing by order time those of the plurality of resting orders having an identical order price and an identical order size.

3. The computer implemented method of claim 1 wherein allocating the volume of the incoming order comprises allocating the incoming order via a pro rata procedure in connection with resting orders of the plurality of resting orders having an identical price and an identical size.

4. The computer implemented method of claim 1 wherein determining the allocation priority listing comprises adjusting a previously established allocation priority listing.

5. The computer implemented method of claim 1 wherein obtaining the order book data comprises:
detecting a trigger event related to a respective order of the plurality of resting orders; and
obtaining the order book data indicative of the respective resting order.

6. The computer implemented method of claim 5 wherein the trigger event comprises entry of the respective resting order of the plurality of resting orders.

7. The computer implemented method of claim 5 wherein the trigger event comprises modification of the respective resting order of the plurality of resting orders.

8. The computer implemented method of claim 1 wherein the fill limit specifies a maximum allocation size for each resting order of the plurality of resting orders.

9. The computer implemented method of claim 1 wherein allocating the volume comprises allocating the incoming order in accordance with the allocation priority list until a predetermined percentage of the incoming order is matched.

10. The computer implemented method of claim 9 further comprising, after reaching the predetermined percentage, allocating a remaining volume of the incoming order in accordance with a further matching procedure.

11. The computer implemented method of claim 1 further comprising:
determining whether allocation of the volume of the incoming order results in a partial fill of one of the plurality of resting orders; and
adjusting the allocation priority listing in accordance with the partial fill.

12. A system for matching an incoming order for a quantity of a financial product, the system comprising:
a processor;
a memory coupled with the processor;
first logic stored in the memory and executable by the processor to cause the processor to obtain order book data indicative of a plurality of resting orders for the financial product that are unmatched and counter to the incoming order;
second logic stored in the memory and executable by the processor to cause the processor to determine an allocation priority listing of the plurality of resting orders based on the order book data, the allocation priority listing having order price as a primary sort criterion, and having order size as a secondary sort criterion to prioritize resting orders of the plurality of resting orders having an identical price; and
third logic stored in the memory and executable by the processor to cause the processor to allocate a volume of the incoming order in accordance with the allocation priority listing by proceeding sequentially through the plurality of resting orders starting with the respective resting order of the plurality of resting orders listed first in the allocation priority listing, such that a successive resting order of the plurality of resting orders in the allocation priority listing is not filled until the respective resting order of the plurality of resting orders currently being filled is either filled completely or a fill limit is met.

13. The system of claim 12 wherein the second logic is further executable by the processor to cause the processor to determine the allocation priority listing such that the allocation priority listing has order time as a tertiary criterion to prioritize resting orders of the plurality of resting orders having an identical price and an identical size.

14. The system of claim 12 wherein the third logic is further executable by the processor to cause the processor to allocate the volume of the incoming order comprises allocating the incoming order via a pro rata procedure in connection with having an identical price and an identical size.

15. The system of claim 12 wherein the second logic is further executable by the processor to cause the processor to adjust a previously established allocation priority listing.

16. The system of claim 12 further comprising fourth logic stored in the memory and executable by the processor to cause the processor to detect a trigger event related to a respective order of the plurality of resting orders, and obtain the order book data indicative of the respective resting order.

17. The system of claim 16 wherein the trigger event comprises entry of the respective resting order of the plurality of resting orders.

18. The system of claim 16 wherein the trigger event comprises modification of the respective resting order of the plurality of resting orders.

19. The system of claim 12 wherein the fill limit specifies a maximum allocation size for each resting order of the plurality of resting orders.

20. The system of claim 12 further comprising fifth logic stored in the memory and executable by the processor to cause the processor to allocate the incoming order in accordance with the allocation priority list until a predetermined percentage of the incoming order is matched.

21. The system of claim 20 further comprising sixth logic stored in the memory and executable by the processor to cause the processor to, after reaching the predetermined percentage, allocate a remaining volume of the incoming order in accordance with a further matching procedure.

22. A computer program product for matching an incoming order for a quantity of a financial product, the computer program product comprising one or more computer-readable storage media having stored thereon computer-executable instructions that, when executed by one or more processors of a computing system, cause the computing system to perform a method, the method comprising:
obtaining order book data indicative of a plurality of resting orders for the financial product that are unmatched and counter to the incoming order;
determining an allocation priority listing of the plurality of resting orders based on the order book data, the allocation priority listing having order price as a primary sort criterion, and having order size as a secondary sort criterion to prioritize resting orders of the plurality of resting orders having an identical price; and
allocating a volume of the incoming order in accordance with the allocation priority listing by proceeding sequentially through the plurality of resting orders starting with the respective resting order of the plurality of resting orders listed first in the allocation priority listing, such that a successive resting order of the plurality of resting orders in the allocation priority listing is not filled until the respective resting order of the plurality of resting orders currently being filled is either filled completely or a fill limit is met.
